(19) United States
(12) Patent Application Publication
(10) Pub. No.: US 2009/0067723 A1
(43) Pub. Date: Mar. 12, 2009

(54) VIDEO IMAGE PROCESSING APPARATUS AND VIDEO IMAGE PROCESSING METHOD

(75) Inventors: Susumu Yamazaki, Musashimurayama-shi (JP); Nobuhiro Kato, Akishima-shi (JP); Tadashi Ishikawa, Kokubunji-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/203,000

(22) Filed: Sep. 2, 2008

(30) Foreign Application Priority Data
Sep. 10, 2007 (JP) 2007-234326

(51) Int. Cl. G06K 9/00; H04N 5/14

(52) U.S. Cl. 382/181; 348/571; 348/E05.062

(57) ABSTRACT

According to one embodiment, a video image processing apparatus includes specification module which is configured to allow specification of a object from a displayed video image, a detection module which is configured to detect whether the object exists in the displayed video image, and control module which is configured to cut out, in the case where the detection module has detected that the object exists, a predetermined area including the object from the displayed video image for display.

### CROSS-REFERENCE TO RELATED APPLICATIONS

This application is based upon and claims the benefit of priority from Japanese Patent Application No. 2007-234326, filed Sep. 10, 2007, the entire contents of which are incorporated herein by reference.

### BACKGROUND

1. Field

One embodiment of the present invention

relates to a video image processing apparatus and a video image processing method suitably applied to, e.g., a digital TV broadcast receiving apparatus.

2. Description of the Related Art

As is well known, in recent years, digitization of TV broadcasting has been promoted. For example, in Japan, not only satellite digital broadcasting, such as broadcasting satellite (BS) digital broadcasting and 110-degree communication satellite (CS) digital broadcasting, but also terrestrial digital broadcasting has been started.

In a digital TV broadcast receiving apparatus configured to receive such digital broadcasts, it is possible to apply a wide variety of video image editing processes to received video image data by using the existing highly sophisticated digital video image processing techniques. Under such circumstances, development of a technique for displaying video images in a more user-friendly manner has been demanded.

Jpn. Pat. Appln. KOKAI Publication No. 2004-173104 discloses a technique for displaying a video image displayed on a large-sized video image display apparatus on the screen of a small-sized terminal device. When a video image on a large sized display is displayed on a small-sized terminal device, user's point of regard on the large-sized display screen is recognized using a camera shooting user's eyeballs, and a video image centering around the point of regard is cut out from the large-sized screen so as to be displayed on the screen of the small-sized terminal device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view showing an embodiment of the present invention, which schematically explains a digital TV broadcast receiving apparatus and an example of a network system constituted with the digital TV broadcast receiving apparatus as a main component;

FIG. 2 is a block diagram for explaining a main signal processing system in the digital TV broadcast receiving apparatus according to the present embodiment;

FIG. 3 is an external view for explaining a remote controller of the digital TV broadcast receiving apparatus according to the present embodiment;

FIG. 4 is a block diagram for explaining an example of a target video image controller provided in the digital TV broadcast receiving apparatus according to the present embodiment;

FIG. 5 is a flowchart for explaining part of a main processing operation executed in the digital TV broadcast receiving apparatus according to the present embodiment;

FIG. 6 is a flowchart for explaining the residual part of a main processing operation executed in the digital TV broadcast receiving apparatus according to the present embodiment;

FIG. 7 is a view for explaining an example of a video image displayed on the digital TV broadcast receiving apparatus according to the present embodiment;

FIG. 8 is a view for explaining another example of a video image displayed on the digital TV broadcast receiving apparatus according to the present embodiment;

FIG. 9 is a view for explaining another example of a video image displayed on the digital TV broadcast receiving apparatus according to the present embodiment;

FIG. 10 is a view for explaining another example of a video image displayed on the digital TV broadcast receiving apparatus according to the present embodiment;

FIG. 11 is a view for explaining another example of a video image displayed on the digital TV broadcast receiving apparatus according to the present embodiment;

FIG. 12 is a view for explaining another example of a video image displayed on the digital TV broadcast receiving apparatus according to the present embodiment; and

FIG. 13 is a view for explaining another example of a video image displayed on the digital TV broadcast receiving apparatus according to the present embodiment.

### DETAILED DESCRIPTION

Various embodiments according to the invention will be described hereinafter with reference to the accompanying drawings. In general, according to one embodiment of the invention, a video image processing apparatus includes: specification module which is configured to allow specification of a object from a displayed video image; a detection module which is configured to detect whether the object exists in the displayed video image; and control module which is configured to cut out, in the case where the detection module has detected that the object exists, a predetermined area including the object from the displayed video image for display.

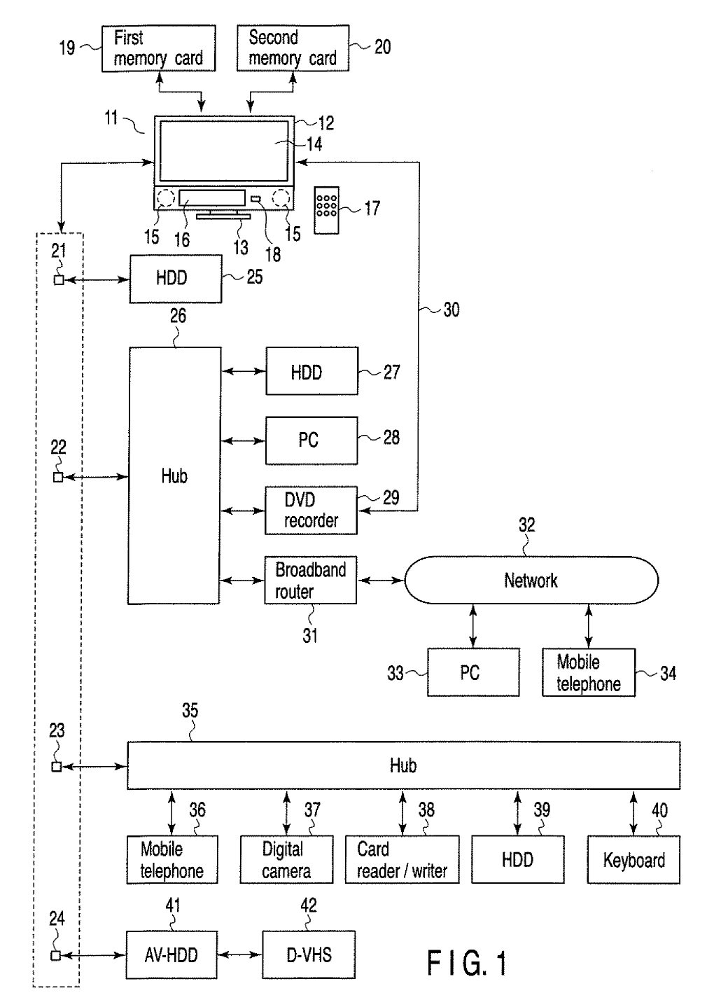

An embodiment of the present invention will be described in detail below with reference to the accompanying drawings. FIG. 1 schematically shows the outer appearance of a digital TV broadcast receiving apparatus 11 to be described in the present embodiment and an example of a network system constituted with the digital TV broadcast receiving apparatus 11 as a main component.

The digital TV broadcast receiving apparatus 11 is mainly composed of a thin cabinet 12, and a support base 13 for supporting the cabinet 12 upright. The cabinet 12 includes a video image display 14 such as a flat-panel display provided with a liquid crystal display panel, a pair of speakers 15, an operation module 16, and a light receiving module 18 for receiving operational information sent from a remote controller 17.

The digital TV broadcast receiving apparatus 11 is configured to have a first memory card 19 detachably loaded thereon, such as an SD (secure digital) memory card, an MMC (multimedia card), or a memory stick. Information including TV programs and photos are recorded in and reproduced from the first memory card 19.

The digital TV broadcast receiving apparatus 11 is also configured to have detachably loaded thereon a second memory card (IC (integrated card) card) 20 carrying, for example, contract information. The contact information is recorded in and reproduced from the second memory card 20.

The digital TV broadcast receiving apparatus 11 includes a first LAN (local area network) terminal 21, a second LAN terminal 22, a USB (universal serial bus) terminal 23, and an IEEE (institute of electrical and electronics engineers) 1394 terminal 24.

The first LAN terminal 21 is used as a LAN specific HDD dedicated port and reproducing information in and from a LAN specific HDD (hard disk drive) 25, which is a NAS (network attached storage) connected to the first LAN terminal 21 over the Ethernet™.

As the first LAN terminal 21 serves as the LAN specific HDD dedicated port, it is possible to stably record information of the programs at high-definition image quality in the HDD 25 regardless of the conditions of the network environment and usage of the network.

Also, the second LAN terminal 22 is used as a common LAN specific port over the Ethernet™. For example, the second LAN terminal 22 may be connected via a hub 26 to a LAN specific HDD 27, a PC (personal computer) 28, and an HDD built-in DVD (digital versatile disk) recording device 29 having a digital broadcast receiving function for exchanging information with each other.

With respect to the DVD recording device 29, digital information communicated via the second LAN terminal 22 is only information of a control system, and therefore, an analog signal transmission path 30 is needed between the DVD recover 29 and the digital TV broadcast receiving apparatus 11 for transmission of analog video image and audio information.

The second LAN terminal 22 is connected via a broadband router 31 connected to the hub 26 to a network 32 such as the Internet, for exchanging information with a PC 33 or a mobile telephone 34 via the network 32.

The USB terminal 23 is used as a common USB specific port. For example, the USB terminal 23 is connected via a hub 35 to a mobile telephone 36, a digital camera 37, a card reader/writer 38 for the memory card, an HOD 39, a keyboard 40, and other USB devices for exchanging information with each other.

The IEEE 1394 terminal 24 is used for serially connection to, for example, an AV (audio-video image)-HDD 41, a D-VHS (digital video home system) 42 for exchanging information with each other.

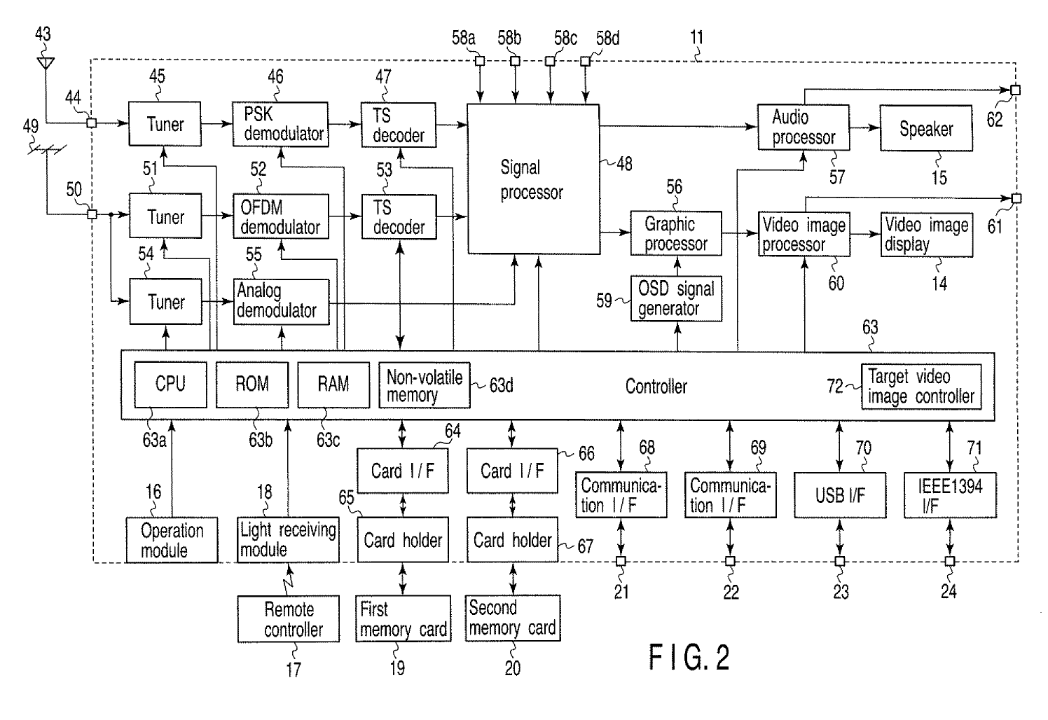

FIG. 2 shows a main signal processing system in the digital TV broadcast receiving apparatus 11. Specifically, a digital satellite broadcast signal received at a BS/CS digital broadcast signal antenna 43 is supplied via an input terminal 44 to a digital satellite broadcast tuner 45, whereby a broadcast signal of a desired channel is selected.

The broadcast signal which has been selected by the tuner 45 is then supplied to a PSK (phase shift keying) demodulator 46 where a TS (transport stream) is demodulated from the received broadcast signal. The TS is then supplied to a TS decoder 47, decoded and separated into a digital video image signal and a digital audio signal, and then output to a signal processor 48.

A digital terrestrial television broadcast signal received at an antenna 49 for terrestrial broadcast reception is supplied via an input terminal 50 to a digital terrestrial broadcast tuner 51, whereby a broadcast signal of a desired channel is selected.

The broadcast signal which has been selected by the tuner 51 is then supplied to an OFDM (orthogonal frequency division multiplexing) demodulator 52 where a TS is demodulated. The TS is then supplied to a TS decoder 53, decoded and separated into a digital video image signal and a digital audio signal, and then output to the signal processor 48.

An analog terrestrial television broadcast signal received at the antenna 49 for terrestrial broadcast reception is supplied via the input terminal 50 to an analog terrestrial broadcast tuner 54, whereby a broadcast signal of a desired channel is selected. The broadcast signal which has been selected by the tuner 54 is supplied to an analog demodulator 55, demodulated to an analog video image signal and an analog audio signal, and then output to the signal processor 48.

The signal processor 48 is provided for selectively applying digital signal processing to the digital video image signal and audio signal supplied from the TS decoders 47 and 53, respectively, and outputting the signals to a graphic processor 56 and an audio processor 57.

The signal processor 48 is connected to a plurality of input terminals (four in the embodiment) 58a, 58b, 58c, and 58d. The input terminals 58a, 58b, 58c, and 58d can receive an analog video image signal and audio signal from the outside of the digital TV broadcast receiving apparatus 11.

The signal processor 48 selectively digitizes the analog video image signal and audio signal respectively supplied from the analog demodulator 55 or the input terminals 58a to 58d, applies predetermined digital signal processing to the digitized video image signal and audio signal and then outputs the signals to the graphic processor 56 and the audio processor 57.

The graphic processor 56 has a function of superimposing an OSD (on screen display) signal generated from an OSD signal generator 59 over the digital video image signal supplied from the signal processor 48. The graphic processor 56 is also configured to selectively output the video image output signal of the signal processor 48 and the OSD output signal of the OSD signal generator 59 and to output both the output signals so as to simultaneously display two separate video images on the screen.

The digital video image signal output from the graphic processor 56 is supplied to a video image processor 60. The video image processor 60 converts the input digital video image signal into an analog video image signal of the format which can be displayed by the video image display 14. Then, the video image processor 60 outputs the analog video image signal to the video image display 14 for displaying the video image and also derives it via an output terminal 61 to the outside.

The audio processor 57 converts the input digital audio signal into an analog audio signal of the format which can be reproduced by the speaker 15. Then, the audio processor 57 outputs the analog audio signal to the speaker 15 for reproducing sound and also derives it via an output terminal 62 to the outside.

All the operations of the digital TV broadcast receiving apparatus 11, including the above-described various receiving operations, are entirely controlled by a controller 63. The controller 63 is equipped with a built-in CPU (central processing unit) 63a for controlling each module such that its operation contents are appropriately reflected in response to operational information received from the operation module 16 or operational information sent from the remote controller 17 via the light-receiving module 18.

In this case, the controller 63 mainly uses a ROM (read only memory) 63b in which control programs to be executed by the CPU 63a are stored, a RAM (random access memory) 63c for providing the working area for the CPU 63a, and a non-volatile memory 63d in which various setting information and control information are stored.

The controller 63 is connected via a card I/F (interface) 64 to a card holder 65 to which the first memory card 19 can be detachably loaded. This allows the controller 63 to exchange information via the card I/F 64 with the first memory card 19 loaded to the card holder 65.

The controller 63 is also connected via a card I/F 66 to a card holder 67 to which the second memory card 20 can be detachably loaded. This allows the controller 63 to exchange information via the card I/F 66 with the second memory card 20 loaded to the card holder 67.

The controller 63 is further connected via a communication I/F 68 to the first LAN terminal 21. This allows the controller 63 to exchange information via the communication I/F 68 with the LAN specific HDD 25 connected to the first LAN terminal 21. In this case, the controller 63 has a DHCP (dynamic host configuration protocol) server function for controlling by assigning an Internet protocol (IP) address to the LAN specific HDD 25 connected to the first LAN terminal 21.

The controller 63 is further connected via another communication I/F 69 to the second LAN terminal 22. This allows the controller 63 to exchange information via the communication I/F 69 with each device (See FIG. 1) connected to the second LAN terminal 22.

The controller 63 is further connected via a USE I/F 70 to the USB terminal 23. This allows the controller 63 to exchange information via the USB I/F 70 with each device (See FIG. 1) connected to the USB terminal 23.

The controller 63 is further connected via an IEEE 1394 I/F 71 to the IEEE 1394 terminal 24. This allows the controller 63 to exchange information via the IEEE 1394 I/F 71 with each device (See FIG. 1) connected to the IEEE 1394 terminal 24.

The controller 63 includes a target video image controller 72. Although the details of the target video image controller 72 will be described later, the target video image controller 72 controls a function of allowing a user to specify a specific object from the video image displayed on the video image display 14, a function of cutting out a predetermined area including the specified object from the video image displayed on the video image display 14, and a function of allowing a user to specify the size and position of the object relative to the entire cut-out area, as well as, controls a function of detecting whether the specified object exists in the video image being displayed on the video image display 14, and a function of displaying a cut-out area including the specified object (if the specified object exists in the video image) on the video image display 14 as a child screen.

Thus, in the case where the object specified by the user exists in the video image displayed on the video image display 14, the object is displayed, in a size or at a position previously specified by the user, on the child screen displayed at a predetermined position in the screen of the video image screen 14, irrespective of the original position of the object in the screen of the video image screen 14. That is, the video image around the object specified by the user is displayed as the child screen in a separated manner from the entire video image, whereby a more user-friendly new video image display form can be obtained.

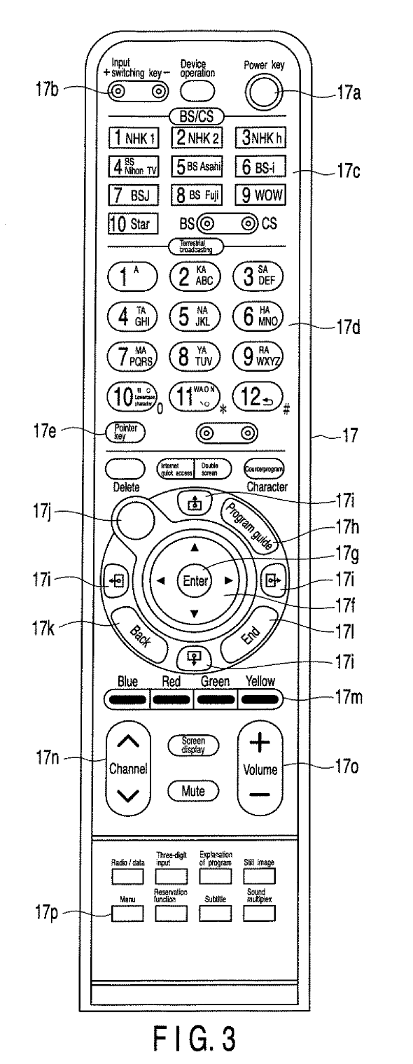

FIG. 3 is an external view of the remote controller 17. The remote controller 17 mainly includes a power key 17a, an input switching key 17b, direct channel-selection keys 17c for satellite digital broadcasting, direct channel-selection keys 17d for terrestrial broadcasting, a pointer key 17e, a cursor key 17f, an enter key 17g, a program guide key 17h, page switching keys 17a, a rolling key 17j, a back key 17k, an end key 17l, color keys 17m for blue, red, green, and yellow, a channel up/down key 17n, a volume control key 17o, a menu key 17p, etc.

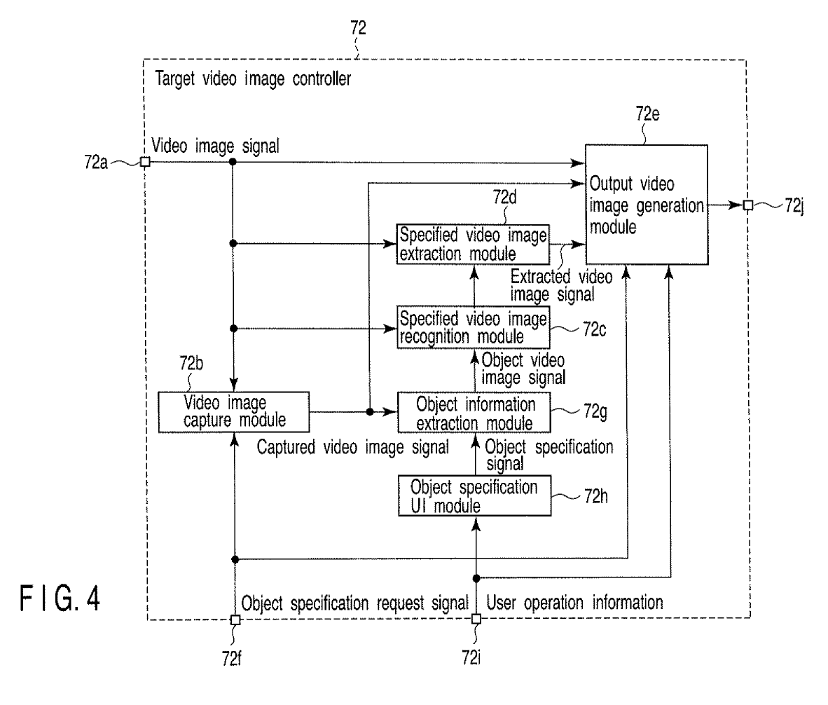

FIG. 4 shows an example of the target video image controller 72. The target video image controller 72 includes an input terminal 72a. A digital video image signal that has been subjected to predetermined demodulation processing or decoding processing is supplied, via the antennas 43, 49 and terminals 21 to 24, to the input terminal 72a.

The digital video image signal supplied to the input terminal 72a is then supplied to a video image capture module 72b, a specified video image recognition module 72c, a specified video image extraction module 72d, and an output video image generation module 72e, respectively.

The video image capture module 72b receives an object specification request signal via a control terminal 72f and, according to the signal, captures the digital video image signal supplied to the input terminal 72a in units of frames and outputs the captured video image signal to an object information extraction module 72g and output video image generation module 72e, respectively. The object specification request signal supplied to the control terminal 72f is also supplied to the output video image generation module 72e.

The object information extraction module 72g performs video image recognition of an object specified by an object specification signal supplied from an object specification UI (user interface) module 72h on the video image signal supplied from the video image capture module 72b, extracts an object video image signal based on the video image recognition result, and outputs the object video image signal to the specified video image recognition module 72c.

The object information extraction module 72g also performs cutting-out of a predetermined area including the object from a displayed video image and setting of the size and position of the object relative to the entire cut-out area based on the object specification signal supplied from the object specification UI module 72h.

The object specification UI module 72h generates the object specification signal based on user operation information supplied thereto via the control terminal 72i and outputs the generated object specification signal to the object information extraction module 72g. The above user operation information is generated when the user operates the operation unit 16 or remote controller 17 and is supplied also to the output video image generation module 72e.

The specified video image recognition module 72c uses the object video image signal supplied from the object information extraction module 72g to perform video image recognition of the object on the input video image signal and outputs the recognition result to the specified video image extraction module 72d. At this time, the specified video image recognition module 72c also outputs information indicating the position of the area cut out from the displayed video image based on the previously set relative size and position of the object in the cut-out area to the specified video image extraction module 72d.

The specified video image extraction module 72d extracts the cut-out area including the object from the input video image signal based on the recognition result supplied from the specified video image recognition module 72c and outputs the extracted video image signal to the output video image generation module 72e. Then, the output video image generation module 72e selectively outputs or outputs in a superimposed manner the video image signal supplied to the input terminal 72a, video image signal captured by the video image capture module 72b, and extracted video image signal output from the specified video image extraction module 72d via an output terminal 72j based on the object specification request signal and user operation information.

The digital video image signal output from the output terminal 72j is then supplied to the signal processor 48, subjected to predetermined digital signal processing in the signal processor 48, and, as described above, subjected to the processing by the graphic processor 56 and video image processor 60, and displayed as a video image on the video image display 14.

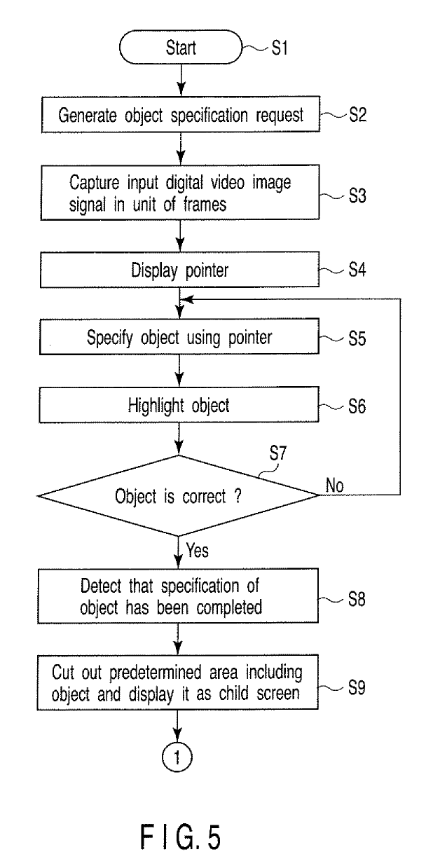

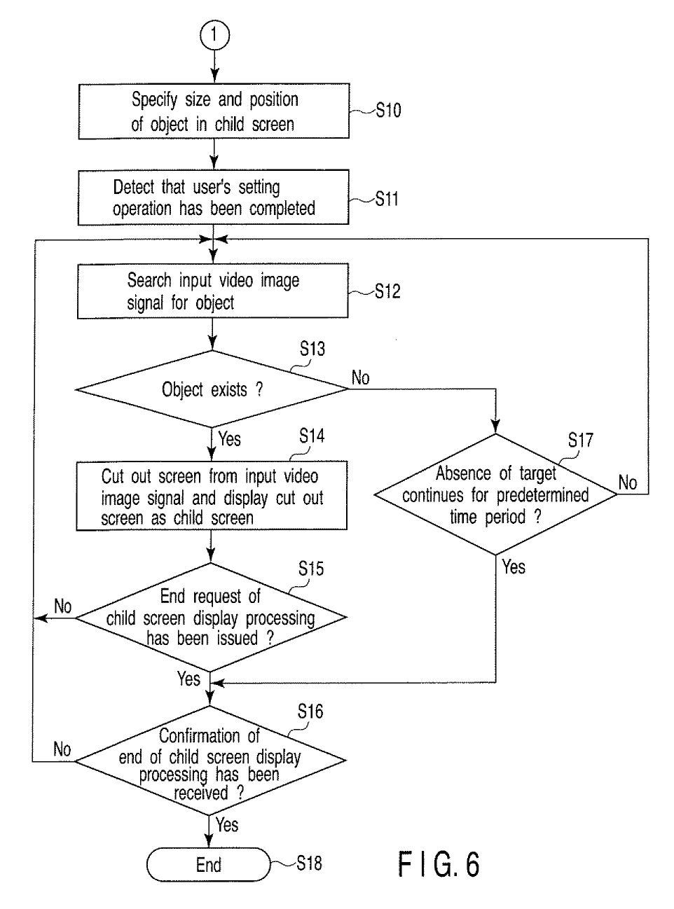

The main processing operation performed using the target video image controller 72 of the digital TV broadcast receiving apparatus 11 having the configuration described above will concretely be described with reference to flowcharts of FIGS. 5 and 6. When the processing is started (step 1), a user generates an object specification request in step S2.

The object specification request is generated when the user operates the menu key 17p of the remote controller 17 to select “object specification request” on an object specification request screen following the menu screen having a hierarchical structure.

When the object specification request has been generated by the user, an object specification request signal is supplied to the video image capture module 72b. When receiving the object specification request signal, the video image capture module 72b captures a digital video image signal supplied to the input terminal 72a in units of a frame in step S3.

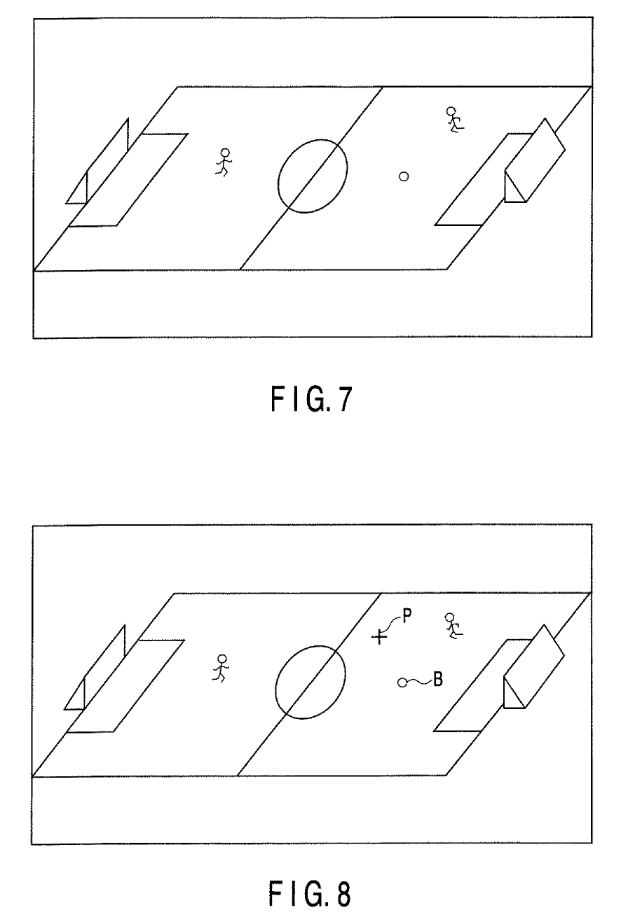

The digital video image signal captured by the video image capture module 72b is supplied to the object information extraction module 72g as well as supplied to the output video image generation module 72e, where the digital video image signal is displayed as a video image on the video image display 14. As a result, a still image as shown in FIG. 7 is displayed on the video image display 14.

Then, in step S4, the user displays a pointer 2 for specifying an object on the still image displayed on the video image display 14 as shown in FIG. 8. The display of the pointer P is enabled when the user operates the pointer key 17e of the remote controller 17 in a state where the still image is displayed based on the object specification request.

After that, in step S5, the user moves the pointer P on the still image displayed on the video image display 14 so as to specify a given object (e.g., ball B in FIG. 8). It is possible for the user to move the pointer P on the still image in the user's desired direction by operating the rolling key 17j of the remote controller 17.

The display of the pointer P in a superimposed manner on the still image which has been captured by the video image capture module 72b and displayed on the video image display 14 or movement of the pointer P is performed by the output video image generation module 72e receiving the operation information from the pointer key 17e or rolling key 17j of the remote controller 17.

The operation information from the pointer key 17e or rolling key 17j of the remote controller 17 is analyzed by the object specification UI module 72h and thereby the position of the pointer P is supplied to the object information extraction module 72g as an object specification signal. As a result, the object information extraction module 72g can identify the object specified by the pointer P on the video image signal captured in the video image capture module 72b.

When the user specifies a specific object using the pointer P on the still image displayed on the video image display 14 and operates the enter key 17g of the remote controller 17, the output video image generation module 72g highlights the specified object on the still image, for example, brightens the specified objected relative to the rest of the image in step S6.

Also in this case, the output video image generation module 72e controls the highlight display of the object specified by the pointer P by receiving the operation information from the enter key 17g of the remote controller 17. The operation information from the enter key 17g of the remote controller 17 is analyzed by the object specification UI module 72h and the resultant information is supplied to the object information extraction module 72g. As a result, the object information extraction module 72g can recognize the detected object on the video image signal captured in the video image capture module 72b as a video image and generate an object video image signal based on the video image recognition result for output.

Then, the user detects in step S7 whether the highlighted object on the still image is correct. When detecting that the object is not correct (NO), the user operates the back key 17k of the remote controller 17. In response to this, the output video image generation module 72e stops the highlight display of the object as well as the object information extraction module 72g stops the generation of the object video image signal. Further, the flow returns to step S5 where an object is specified once again using the pointer P.

When detecting in step S7 that the object highlighted on the still image is correct (YES), the user operates the enter key 17g of the remote controller 17 in step S8. As a result, the object information extraction module 72g detects that the specification of the object has been completed and outputs the object video image signal which is the result of the video image recognition of the object that is being recognized to the specified video image recognition module 72c.

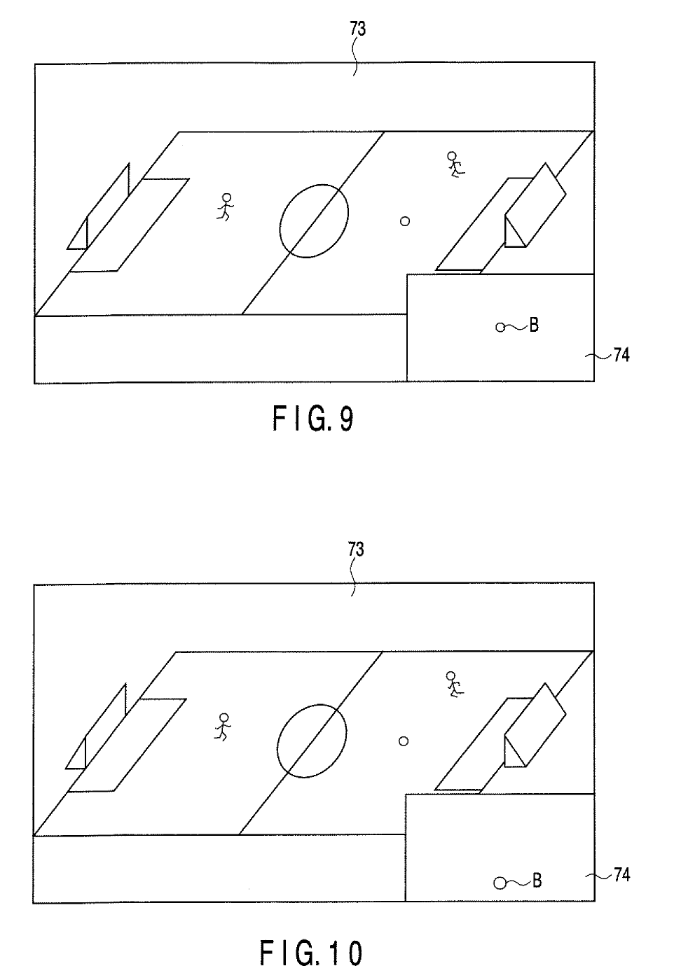

In step S9, the object information extraction module 72g performs control so as to automatically cut out a predetermined area including the specified object from the still image and display the video image corresponding to the cut-out area as a child screen. As a result, as shown in FIG. 9, a child screen 74 displaying the object (ball B) at the center thereof is displayed at a predetermined position (in the case of FIG. 9, lower right corner) of the entire video image [main (parent) screen 73] is displayed on the video image display 14.

After that, in step S10, the object information extraction module 72g specifies the size and position of the object relative to the entire child screen 74 based on a user's operation. The size of the object in the child screen 74 is specified by the user operating the channel up/down key 17n of the remote controller 17.

For example, when the user operates the channel up/down key 17n in the channel-up direction, the size of the object is increased; while the user operates the channel up/down key 17n in the channel-down direction, the size of the object is reduced. The position of the object in the child screen 74 is specified by the user operating the cursor key 17f of the remote controller 17 and moving the displayed video image in the child screen 74 in the up-down and left-right directions.

As a result, the size and position of the object relative to the entire child screen 74 are specified as shown in FIG. 10. In FIG. 10, the object (ball B) is increased in size to be larger than that of the ball displayed on the main (parent) screen 73 and is positioned at the lower center portion of the child screen 74. The setting information indicating the size and position of the object relative to the entire child screen 74 is supplied from the object information extraction module 72g to the specified video image recognition module 72c.

As described above, after the object has been specified on the still image captured in the video image capture module 72b and the size and position of the object have been detected on the cut-out area (child screen 74) including the specified object, the object information extraction module 72g detects, in step S11, that the setting operation performed by the user has been completed.

Then, in step S12, the specified video image recognition module 72c searches the video image signal supplied thereto via the input terminal 72a, in the units of a frame, for a video image (object) corresponding to the object video image signal supplied from the object information extraction module 72g using a video image pattern recognition algorithm and, in step S13, detects whether the object exists in each video image frame.

When detecting that the object exists (YES), the specified video image recognition module 72c outputs, to the specified video image extraction module 72d, cut-out information indicating an area to be cut out from the input video image signal according to the setting information indicating the magnification factor and position of the object, which is supplied from the object information extraction module 72g.

Then, in step S14, the specified video image extraction module 72d performs cut-out of a screen from the input video image signal based on the cut-out information supplied from the specified video image recognition module 72c and outputs the obtained extracted video image signal to the output video image generation module 72e. The output video image generation module 72e combines the extracted video image signal with the input video image signal so that the extraction video image signal is displayed as the child screen and outputs the resultant video image signal.

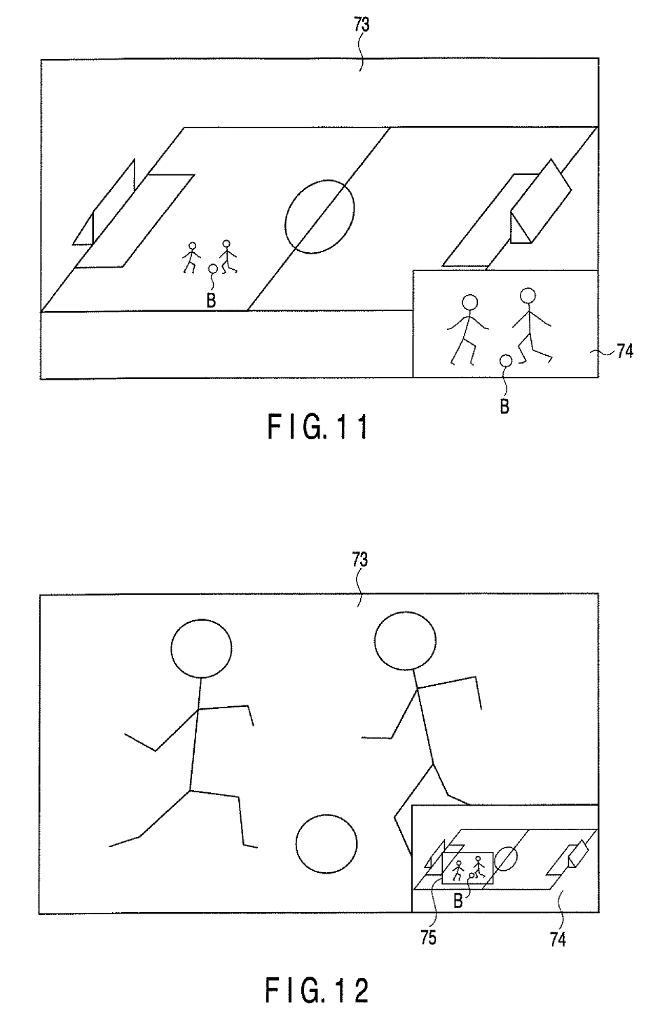

As a result, in the case where the object (ball B) exists on the main (parent) screen 73, the object is displayed, in a size or at a position previously specified, on the child screen 74 as shown in FIG. 11. Thus, the user can view the video image of the surrounding area of the object specified by himself or herself on the child screen 74 in an enlarged manner, whereby a more user-friendly new video image display form can be obtained.

In step S15, the target video image controller 72 detects whether an end request of the child screen display processing has been issued from the user via the object specification UI module 72h. The end request of the child screen display processing is generated by the user operating the end key 17l of the remote controller 17 in the child screen 74 display state.

When it is detected that the end request has not been Issued (NO), the flow returns to step S12 from which the processing of searching the input digital video image signal for the object in units of a frame is repeated.

When it is detected that the end request has been issued (YES), the target video image controller 72 confirms, in step S16, with the user whether he or she wants to end the child screen display processing. In this confirmation, the target video image controller 72 displays two options “END” or “NOT END” on the video image display 14 together with a message saying “End child screen display processing?”. The user then selects one of the choices by operating the cursor key 17f of the remote controller 17 followed by depressing of the enter key 17g for execution of the selected processing.

When it is detected, in step S16, that the confirmation of the end of the child screen display processing has not been received (NO), the flow of the target video image controller 72 returns to step S12 from which the processing of searching the input digital video image signal for the object in units of frames is repeated. When it is detected, in step S16, that the confirmation of the end of the child screen display processing has been received (YES) in step S16, this flow is ended (step S18).

When it is detected, in step S13, that the object does not exist in the input video image frame (NO), the target video image controller 72 detects whether a state where the object does not exist in the input video image frame continues for a predetermined time period in step S17. When it is detected that the absence of the target has not continued for a predetermined time (NO), the flow returns to step S12. When it is detected that the absence of the target has continued for a predetermined time (YES), the flow shifts to step S16.

According to the above embodiment, when the user previously specifies an object to which he or she wants to pay attention from the displayed video image and the specified object exists in the input video image, a predetermined area including the object is cut out according to the previously specified size and position and displayed as the child screen. That is, the video image of the surrounding area of the user's specified object is displayed as the child screen in a separated manner from the entire video image, whereby a more user-friendly new video image display form can be obtained.

Upon detection of the object on the still image captured in the video image capture module 72b, the object is displayed at the center portion of the cut-out area including the object with a certain magnification factor. It is preferable, in terms of user operability, that the setting of the size and position of the object relative to the entire cut-out area can be achieved, by the use of the remote controller 17, in such a manner as if the user operates a video camera or the like (i.e., it is preferable to achieve pan, tile, zoom-in, and zoom-out control using the remote controller 17). For example, when the screen is panned to the right, the object relatively moves to the left; while when the screen is panned upward, the object moves downward. This motion control is realized by a G sensor sensing such a movement.

In the case where an object having a complicated shape, such as the face of an individual is selected, it is difficult to identify the individual from the input video image only with the object video image signal acquired from one frame of a still image. In this case, the face of the target individual is captured from a plurality of different angles, and the captured video images are linked as one object. With this method, object recognition accuracy can be increased. Further, by calling the object video image signal that has been registered in the previous viewing time, highly accurate recognition can be achieved without making various settings at every viewing time.

Further, a configuration may be employed in which video images obtained by shooting the same object from different angles are input every time, and are then automatically subjected to user selection. For example, in the case of a football, three video images, “panoramic view of pitch”, “area in front of goal of favorite team”, and “area in front of goal of opposing team” are input at one time. From the video images, the user can select the image containing the object that he or she likes best.

Further, a configuration may be employed in which only the cut-out area (child screen portion) is recorded and only the recorded child screen portion is reproduced for viewing. This is beneficial for the user.

Further, a configuration may be employed in which, as shown in FIG. 12, the cut-out area including the object set by the user is displayed as the main (parent) screen 73, and the entire video image is displayed as the child screen 74. In this case, a frame 75 indicating the display portion of the main (parent) screen 73 in the child screen 74 so as to allow the user to recognize which portion of the entire image is being displayed on the main (parent) screen 73.

Further, a configuration may be employed in which two or more objects are specified so as to be recognized simultaneously. In this case, the relative position between the recognized objects is detected. For example, a ball and a goalpost are specified as the objects, and the relative distance between them is measured based on the sizes thereof and distance therebetween on the screen. When the two objects come close to each other and the distance therebetween reaches a predetermined value, the cut-out area including both objects is displayed as the child screen 74.

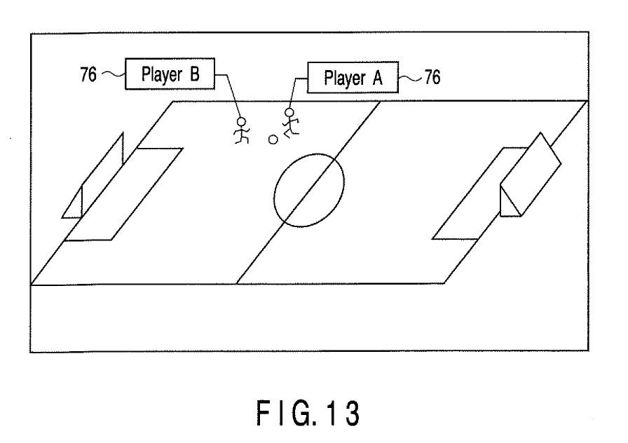

Further, a configuration may be employed in which, as shown in FIG. 13, the portion at which the object exists can be indicated by attaching a tag 76 to the object recognized using a video image pattern recognition algorithm as a mark or by highlighting (flashing) the recognized object with a complementary color. Also in this case, two or more objects may be specified.

Further, it is possible to emphasize the recognized object as if it were popped up by focusing out the background of the object recognized using a video image pattern recognition algorithm.

In the case where a plurality of frames including the target continue, when magnification display is performed for each frame after the detection of the object and setting of the cut-out area, fine wobbling occurs between the cut-out areas of each frame. Since the video image of the cut-out area is displayed in an enlarged manner, the wobbling is highly visible, making the object and its surrounding area difficult to view.

Therefore, in the case where a plurality of frames including the target continue, the video image frames are appropriately thinned-out so as to make the wobble less noticeable. Concretely, a method that measures the wobble of the object is measured between the cut-out areas and thins out the frame in which the position of the object is displaced relative to a reference position, or method that measures the cycle of the frame wobble of the object in the cut-out and thins out the frame using the measured cycle can be employed.

In the case where the size of the object in the screen is changed after specification of the object, the magnification factor of the object in the cut-out area is automatically adjusted so that the size of the object displayed on the cut-out screen is always kept constant Concretely, a method that changes the size of the cut-out screen while keeping the magnification factor of the object constant or method that changes the magnification factor of the object while keeping the size of the cut-out screen constant may be employed.

Further, in order to display the object at a previously set position on the cut-out screen, a method that calculates the geometric center or barycenter of the plan video image of the object and places the calculated position on the set position on the cut-out screen may be employed.

A technique that detects the specified object from the entire displayed video image using a video Image pattern recognition algorithm as described above can be applied to a video camera. In this case, for example, when the entire view is displayed in a zoom-out mode after a target subject (object) is specified in a zoom-in mode, a technique such as the one that attaches the tag 76 to the object is used so as not to lose sight of the object.

Further, in the case where the object is displayed in an enlarged manner on the cut-out screen, when the object is enlarged beyond the resolution of the original video image, the video image quality is deteriorated. In this case, a super-resolution technique or the like is used so as to enhance the quality of the video image. The super-resolution technique is referred to as “in-frame degradation inverse transformation” and has a feature of sharpening the edge particularly in the enlargement processing so as to generate a sharp video image and generating an enlarged video image not from a plurality of frames but from only one frame.

The processing procedure is as follows: first, a tentative enlarged video image is generated from the original video image using a normal filter and, then, the pixel value (luminance) of the tentative video image is compensated so as to generate a real enlarged video image. In the compensation, a technique called “convex projection” is used. This technique has a feature of calculating the pixel value from the pixel value of the tentative enlarged video image according to a calculation model and feeding back a difference between the calculated pixel value and pixel value of the original video image to the enlarged video image. With regard to the edge portion, the compensation using the convex projection is applied also to its self-congruent points.

More concretely, this resolution enhancement technique focuses on the point that when a part of the object is cut out and the change pattern of the pixel value thereof is observed, the same pattern as the pixel change pattern exists near the cut out portion and detects the positions of a plurality of sample values corresponding to the same pixel value change pattern which exist in one frame. That is, a Sobel filer or the like is used to acquire the edge from an input low resolution video image and, then, information (e.g., binary image) concerning the edge is acquired.

Then, one low resolution pixel and a plurality of corresponding points near the low resolution pixel having a similar luminance pattern are searched for in an area detected as the edge. To perform the correlation detection of the luminance pattern, SAD (Sum of Absolute Difference) or SSD (Sum of Squared Difference) can be used. Further, as the search method for obtaining a plurality of corresponding points, a method that sets a search range in units of pixels in one (x-axis or y-axis) direction and changes the component of another axis may be employed. In this case, some points obtained by changing the component of another axis are selected as candidates of highly correlated points, and a technique such as a parabola fitting is used to estimate the coordinate of the corresponding points in units of sub-pixel.

Then, the low resolution pixel value and information of the plurality of corresponding points are used to calculate a high resolution pixel value. As a concrete calculation method of the high resolution pixel value, there is known, e.g., a POCS method (see “Super-Resolution Image Reconstruction: A Technical Overview” written by S. Parkr et. al. page 29). In the POCS method, a bilinear interpolation method or a cubic convolution interpolation method is used to previously calculate the tentative pixel value of the high resolution video image. Although it is necessary for the sample value (sub-pixel unit) obtained based on the corresponding points of the target pixel of the low resolution video image to be reproduced by a set of pixel values of pixels of the high resolution video image arranged in units of one pixel, the tentative pixel value does not meet this requirement in general. Since a tentative sample value obtained by mapping of pixels to the high resolution video image based on the sample value does not coincide with a pixel value tentatively obtained, a difference between them is calculated and the tentative pixel value is updated by being subjected to addition or subtraction so that the difference is eliminated. The update is also carried out at the adjacent target pixels, which influences the tentative pixel value to change its correct value to an incorrect one. In order to cope with this, a plurality of update processing are repeated for all the sample points. This repetition of the update processing brings the tentative pixel value gradually close to a correct value. The video image obtained by repeating the update processing by a number of times is output as the high resolution video image.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video image processing apparatus comprising:
a specification module configured to specify an object from video images based on received video image signals;
a recognition module configured to visually recognize the object from the received video image signals; and
a control module configured to extract a video image signal corresponding to a predetermined area configured to include the object from the received video image signals, the control module being also configured to output the extracted video image signal.

2. The video image processing apparatus according to claim 1, wherein:
the recognition module is configured to include a detection module configured to visually detect the object from the received video image signals, the detection module being also configured to detect whether the object is present; and
when the object is detected as being present, the control module is configured to extract the video image signal corresponding to the predetermined area in which the object is included, from the received video image signals, and to output the extracted video image signal.

3. The video image processing apparatus according to claim 1, wherein:
when receiving a request of specifying the object from the video images displayed based on the received video image signals, the specification module is configured to make the displayed video image stationary.

4. The video image processing apparatus according to claim 1, wherein the control module is configured to specify size or a position of the object displayed in a predetermined area which has been extracted from the received video image signals.

5. The video image processing apparatus according to claim 4, wherein:
when the size of the object in the video image displayed based on the received video image signal is changed, the control module is configured to perform control so as to keep the size of the object displayed in the extracted predetermined area at a specified size.

6. The video image processing apparatus according to claim 1, wherein:
the received video image signals and the video image signal corresponding to the predetermined area extracted by the control module are displayed on the same screen such that one of them is displayed as a main screen and the other is as a child screen.

7. The video image processing apparatus according to claim 6, wherein:
in the case where the video image based on the received video image signals is displayed in the child screen and a video image based on the video image signal corresponding to the predetermined area extracted by the control module is displayed in the main screen, an indicator indicating an image portion presently displayed on the main screen is configured to be displayed on the child screen.

8. The video image processing apparatus according to claim 1, wherein:
when the video image to be displayed in the predetermined area extracted by the control module is displayed, the frames of the received video image signals are thinned out.

9. The video image processing apparatus according to claim 1, wherein:
when the video image to be displayed in the predetermined area extracted by the control module is displayed, signal processing using a super-resolution technique is applied to the received video image signals.

10. A video image processing apparatus comprising:
a specification module configured to specify an object from video images being displayed;
a detection module configured to detect whether the object is included in the video images being displayed; and
a control module configured to be responsive to a case where the detection module detects that the object is present, and to extract a predetermined area including the object from the displayed video images being displayed.

11. A video image processing method comprising:
specifying a object from video images based on received video image signals;
visually recognizing the object from the received video image signals; and
extracting a video image signal corresponding to a predetermined area that includes the recognized object, from the received video image signals, and outputting the extracted video image signal.

12. The video image processing method according to claim 11, wherein:
said visually recognizing the object includes visually detecting the object from the received video image signals; and detecting whether the object is present; and
when the object is detected to be present, said outputting the extracted video image signal includes extracting the video image signal corresponding to the predetermined area that includes the object, from the received video image signals, and outputting the extracted video image signal.
